(19) United States
(12) Patent Application Publication
(10) Pub. No.: US 2009/0235004 A1
(43) Pub. Date: Sep. 17, 2009

(54) Message Signal Interrupt Efficiency Improvement

(75) Inventors: Anh Dang, Round Rock, TX (US); Jim Gallagher, Austin, TX (US); Binh Hua, Austin, TX (US); Hong Hua, Austin, TX (US)

Correspondence Address: Cahn & Samuels, LLP, 1100 17th St., NW, Ste. 401, Washington, DC, 20036, US

(73) Assignee: INTERNATIONAL BUSINESS MACHINES CORPORATION, Armonk, NY (US)

(21) Appl. No.: 12/049,070

(22) Filed: Mar. 14, 2008

(51) Int. Cl. G06F 13/24

(52) U.S. Cl. 710/267

(57) ABSTRACT

A system and method for improving the efficiency of Message Signal Interrupts (MSI) in computer systems. The system utilizes the unused memory addresses in the MSI data payload to identify MSI transmit packets and to indicate the status of the interrupt without the need to further probe the device in order to determine the interrupt status.

### I. FIELD OF THE INVENTION

This invention relates to a system and method for improving the efficiency of Message Signal Interrupts (MSI) in computer systems by utilizing the unused memory addresses in the data payload to indicate status of the interrupt without the need to further probe the device in order to determine the interrupt status.

### II. BACKGROUND OF THE INVENTION

In computing technology, interrupts are asynchronous signals from hardware, such as peripheral components, alerting the need for attention or a synchronous event that alerts the need for a change in execution in software. Interrupts initiates computer processors to save the existing state of execution of the system. Modern computer peripherals, for example, use interrupts to signal the operating system (OS) of a new event occurring.

Legacy interrupt (LSI) only supports a max of four (4) interrupts per peripheral device. Until recently, this limitation of interrupts did not present a significant problem. However, new functions such as TOE, IO virtualization, etc., request more interrupt types per device. In order to overcome this limitation, the Message Signal Interrupt (MSI) has been defined in Peripheral Component Interconnect (PCI) Local Bus Specification.

MSI enables a device function to request interrupt services by sending an Inbound Memory Write on its PCI bus to the system as a MSI transaction. The MSI memory write consists of a 32-bit data to specific memory location or memory address that is set up on the device during initialization. According to the PCI Specification, this 32-bit data consists of the MSI message data (16-bit) that is set to the device during initialization. This data field is used to identify different types of events (up to 32 types are allowed by the specifications). The lower 16-bit is not used and is set to 0.

The cost associated with the system or device supporting a 32-bit interrupt is significant. Further, many system and input/output (I/O) vendors chose to support small numbers of interrupt types. With fewer interrupts supported on MSI, there are only enough interrupts available to differentiate the interrupt types. Therefore, the OS driver is required to perform an I/O register read to determine the cause of the interrupt.

As an example, when fewer interrupt types are supported a MSI interrupt could indicate that a packet has been received (Rx interrupt). However, that interrupt would not indicate the type of packet, i.e., whether it is “good” or “bad”. “Bad” interrupts might be caused by various errors such as, for example, CRC error, parity error, packet being too short, etc. With too few MSI interrupts supporting the system and I/O adaptor, the driver still has to go out and probe the device after receiving the MSI interrupt in order to determine the exact cause of the interrupt. This process on the MSI interrupt ultimately requires more time than the LSI.

There remains a need to quickly and efficiently determine the status of MSI interrupts without the need for the driver to probe the device after receiving the MSI interrupt signal.

### III. SUMMARY OF THE INVENTION

In at least one embodiment the present invention provides a method for improving the efficiency of computer system message signal interrupts (MSI), including: locating unused memory in the message signal interrupt data payload of a computer system; formatting the unused memory to identify a message signal interrupt packet and the status of said message signal interrupt packet in the same signal; and using said message signal interrupt packet and said message signal interrupt packet status to resolve problems related to said packets without further probing the computer system.

An objective of the present invention is to provide a means of determining the status of MSI interrupts without the need to further probe the device after receiving the MSI interrupt signal.

### IV. BRIEF DESCRIPTION OF THE DRAWINGS

The present invention is described with reference to the accompanying drawings, wherein:

FIG. 1 illustrates the format of a computer system Memory Write Transaction for Native Device MSI delivery including unused memory addresses in accordance with an exemplary embodiment of the present invention.

FIG. 2 illustrates an example of a method of utilizing the unused memory addresses in the data payload of the Message Signal Interrupt (MSI) in accordance with an exemplary embodiment of the present invention.

Given the following enabling description of the drawings, the apparatus should become evident to a person of ordinary skill in the art.

### V. DETAILED DESCRIPTION OF THE DRAWINGS

The present invention utilizes the unused memory addresses in the data payload of the Message Signal Interrupt (MSI) memory write transaction in order to provide more detail associated with interrupt events to the operating system (OS) software. The unused data field (often 16-bit) in the MSI data field is formatted to pass up additional information to that specific MSI interrupt type. The unused data field may be formatted to be used as numbers of work done or error detection bit.

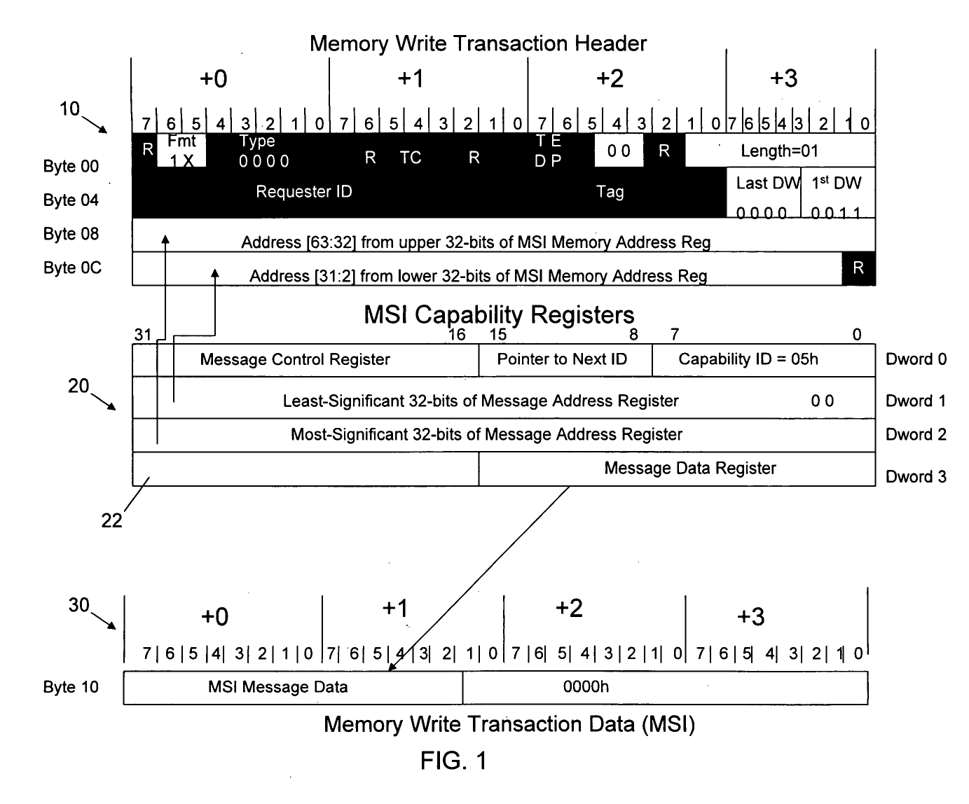

FIG. 1 illustrates an exemplary architectural format of a computer system Memory Write Transaction for Native Device MSI delivery of the present invention. This exemplary Memory Write Transaction includes a Memory Write Transaction Header 10, MSI Capability Registers 20, and Memory Write Transaction Data 30. MSI Capability Registers 20 includes 16 unused (lower) bits 22 in the data payload of the MSI memory write transaction 10. These unused bits 22 (including 8 bits dedicated to status and 8 bits dedicated to descriptor reads) allows the system to indicate status on the interrupt type. This additional information enables the OS software to handle the interrupt event without the further probing (MMIO/descriptor read) the device for more status.

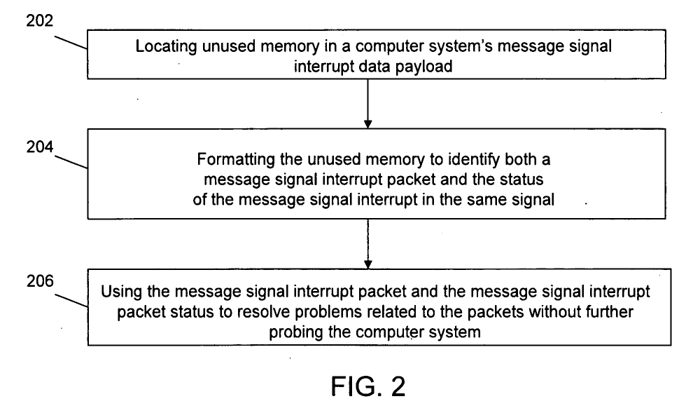

FIG. 2 illustrates a method of utilizing the unused memory addresses in the data payload of the Message Signal Interrupt (MSI) of the present invention. At 202, the system locates unused memory in the Message Signal Interrupt (MSI) data payload. At 204, the system formats the located unused memory to identify a Message Signal Interrupt (MSI) packet and the status of the Message Signal Interrupt (MSI) in the same signal. At 206, the system uses the Message Signal Interrupt (MSI) packet and the Message Signal Interrupt (MSI) status to resolve problems related to the packets. Because the Message Signal Interrupt (MSI) includes both the packet as well as the packet status on the same signal there is no need to further probe the computer system in order to determine the packet status. This method provides a faster and more efficient method of resolving problems associated with Message Signal Interrupt (MSI) packets.

The present invention allows the unused 16 bits 22 in the MSI data field to be formatted, for example by an IO adaptor hardware designer, to pass up additional information to that specific MSI type interrupt. 8 bits of the unused 16 bits are used to transmit the additional information can include numbers of work done or error detection bit. The example listed below illustrates how the present invention is utilized to improve overall system performance. The system indicates each individual transmit (Tx) descriptor process since the last interrupt by a corresponding process number along with the transmit (Tx) status of the interrupt.

| 8 bit | 8 bit |
|---|---|
| Transmit (Tx) descriptor | Transmit (Tx) status |
| process number | |

Char num-tx-desc-done; /* number of transmit
(Tx) packets that IO adaptor has
processed since the last interrupt */
Char Tx_status; /* Tx packet status
0x0000 = good Tx packet
0x0001 = bad Tx TCP/IP checksum packet
0x0002 = Tx packet too big
0x0003 = Tx packet too small
0x0004 = Tx packet over run
:
:
:
0x1000 = illegal Tx descriptor format */

In the example above, when the transmit (Tx) packet was found to be good, the OS driver dis not need to check the Tx status one packet at a time and free resources one at a time. This allows the system to free multiple Tx buffers and descriptors together based on the additional information contained in the MSI payload. This point is further illustrated when multiple packets are transmitted. When, for example, the num-tx-desc-done=64 and Tx_status=0×0000 the OS driver knows that there are 64 Tx descriptors that have good Tx status. Based on this information 64 Tx buffers and 64 descriptors can be freed by the system. Without the additional information, the OS driver may need to perform memory reads 64 times on 64 descriptors in order to check the status of each Tx packet. By avoiding this additional requirement the system saves CPU usage and improves Tx packet process latency.

Also referring to the example above, when the transmit (Tx) packet was found to be bad, the num-tx-desc-done=60 and Tx_status=0×1000. The additional information indicated that the adapter had not completed processing the number 60 descriptor because of an illegal Tx descriptor format. This information also confirms that processing of packets 1 through 59 has been completed with good status. Therefore, the resources related to packets 1 through 59 can be freed and only the status related to Tx packet 60 needs to be resolved.

The invention can take the form of an entirely hardware embodiment, an entirely software embodiment or an embodiment containing both hardware and software elements. In at least one exemplary embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As will be appreciated by one of ordinary skill in the art, the present invention may be embodied as a computer implemented method, a programmed computer, a data processing system, a signal, and/or computer program. Accordingly, the present invention may take the form of an entirely hardware embodiment, an entirely software embodiment or an embodiment combining software and hardware aspects. Furthermore, the present invention may take the form of a computer program on a computer-usable storage medium having computer-usable program code embodied in the medium. Any suitable computer readable medium may be utilized including hard disks, CD-ROMs, optical storage devices, carrier signals/waves, or other storage devices.

The exemplary embodiments described above may be combined in a variety of ways with each other. Furthermore, the steps and number of the various steps illustrated in the figures may be adjusted from that shown.

Although the present invention has been described in terms of particular exemplary embodiments, it is not limited to those embodiments. Alternative embodiments, examples, and modifications which would still be encompassed by the invention may be made by those skilled in the art, particularly in light of the foregoing teachings.

Those skilled in the art will appreciate that various adaptations and modifications of the exemplary embodiments described above can be configured without departing from the scope and spirit of the invention. Therefore, it is to be understood that, within the scope of the appended claims, the invention may be practiced other than as specifically described herein.

1. A method for improving the efficiency of computer system message signal interrupts (MSI), comprising:
locating unused unallocated lower bits of memory in the message signal interrupt data payload of a computer system;
formatting the unallocated lower bits of memory to identify a message signal interrupt packet and a status of said message signal interrupt packet in a same signal; and
using said message signal interrupt packet and said status of said message signal interrupt packet to resolve problems related to said packets without further probing the computer system.
